(19) United States
(12) Patent Application Publication
(10) Pub. No.: US 2006/0108416 A1
(43) Pub. Date: May 25, 2006

(54) Unauthorized access prevention method

(75) Inventor: Tadahiko Hirai, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/538,037

(22) PCT Filed: Mar. 26, 2004
(86) PCT No.: PCT/JP04/04341

§ 371 Date: Jun. 8, 2005

(30) Foreign Application Priority Data
Mar. 31, 2003 (JP) 2003-094813

(51) Int. Cl. G06K 5/00; G06K 19/06

(52) U.S. Cl. 235/382; 235/492

(57) ABSTRACT

An unauthorized access prevention method is provided for an integrated circuit including one or plural resistor elements capable of selecting between a high impedance state and a low impedance state irreversibly in an interface portion within the integrated circuit or a peripheral circuit portion. When a signal inconsistent with verification information and standard that are preset in the integrated circuit is received at least once, the impedance state of the resistor element is changed from an initial state to stop a part or all of accesses to the integrated circuit irreversibly. The unauthorized access prevention method is thus implemented by a simple structure manufactured with ease and at low cost.

### TECHNICAL FIELD

The present invention relates to an unauthorized access prevention method for an integrated circuit.

### BACKGROUND ART

In recent years, products using a semiconductor integrated circuit such as information tags, IC cards, credit cards, and prepaid cards have been introduced into the market, and are gradually expanding their share in the market. Such information tags and cards are often referred to as “smart cards” in general, and are said to be more counterfeit-resistant than magnetic stripe cards. It is however a fact that keywords or logic circuit structures within the cards are analyzed to cause unending damages of forgery, tampering, and impersonation. Countermeasures that have been administered against such damages in order to enhance safety of the smart cards include increasing data widths and complicating logics. However, all those countermeasures are significantly high in cost, so that there are naturally limitations in the smart card market under strong pressure for lower prices. (For further details, see Japanese Patent Application Laid-Open No. H07-110876.)

Further, cryptographic techniques high in secrecy, application of which are not limited to the smart cards, require a system that adopts such a key as to have a key length exceeding 128 bits and includes a large-scale microprocessor, being expected to become further larger-scale and complicated in the future. Details on the techniques are described in “Studies on implementation method for encryption algorithm and risk analysis thereon” (issued on Feb. 28, 2003 by Information-technology Promotion Agency/Information-technology SEcurity Center).

### DISCLOSURE OF INVENTION

The present invention is to solve the conventional problem in that integrated circuits highly resistant to forgery, impersonation, and unauthorized accesses are complicated and expensive. The present invention therefore has an object to provide an unauthorized access prevention method implemented by a simple structure manufactured with ease and at low cost.

Therefore, according to the present invention, there is provided an unauthorized access prevention method for an integrated circuit including one or plural resistor elements capable of selecting between a high impedance state and a low impedance state irreversibly in an interface portion within the integrated circuit or a peripheral circuit portion,

in which, when a signal inconsistent with verification information and standard that are preset in the integrated circuit is received at least once, the impedance state of the resistor element is changed from an initial state to stop a part or all of accesses to the integrated circuit irreversibly.

According to the present invention, it becomes possible to structure an integrated circuit highly resistant to forgery, impersonation, and unauthorized accesses with a simple method.

Further, a highly safe IC card can be realized.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram showing a concept of a circuit according to a first embodiment;

FIG. 2 is a graph showing electrical characteristics of a resistor element in the circuit of FIG. 1;

FIG. 3 is a schematic diagram showing a concept of a circuit according to a second embodiment; and

FIG. 4 is a graph showing electrical characteristics of a resistor element in the circuit of FIG. 3.

### BEST MODE FOR CARRYING OUT THE INVENTION

Preferred embodiments of the present invention will now be described in detail in accordance with the accompanying drawings.

The present invention relates to an unauthorized access prevention method for an integrated circuit including one or plural resistor elements capable of selecting between a high impedance state and a low impedance state irreversibly in an interface portion within the integrated circuit or a peripheral circuit portion, in which, when a signal inconsistent with verification information and standard that are preset in the integrated circuit is received at least once, the impedance state of the resistor element is changed from an initial state to stop a part or all of accesses to the integrated circuit irreversibly.

It is preferable that the resistor element contain an organic conductor.

It is preferable that the resistor element be formed of a capacitor.

It is preferable that a voltage higher than at normal operation be applied to the resistor element in order to change its impedance.

It is preferable that a current larger than at normal operation be applied to the resistor element in order to change its impedance.

It is preferable that the verification information and standard that are preset in the integrated circuit contain a keyword or a logic.

It is preferable that the verification information and standard that are preset in the integrated circuit contain a clock frequency different from that in a specification.

It is preferable that the verification information and standard that are preset in the integrated circuit contain a power supply voltage different from that in a specification.

It is preferable that the integrated circuit contain an organic semiconductor.

An IC card which uses the above-mentioned unauthorized access prevention method is also preferable.

The present invention is characterized by including one or plural resistor elements capable of selecting between a high impedance state and a low impedance state irreversibly in an interface portion within the integrated circuit or a peripheral circuit portion, in which, when a signal inconsistent with verification information and standard that are preset in the integrated circuit is received at least once, the impedance state of the resistor element is changed from an initial state to stop a part or all of accesses to the integrated circuit irreversibly. The interface portion is a circuit portion for inputting/outputting a signal to/from the integrated circuit. Also, the peripheral circuit portion is a circuit portion other than a memory array and a microprocessor core. According to the present invention, the resistor element is in the high impedance state or the low impedance state. That is, there are two states with a high resistance and a low resistance, either of which is the initial state and can be changed. The signal inconsistent with the verification information and standard that are preset in the integrated circuit is selected from a keyword, a logic, a power supply voltage, a drive frequency (clock frequency), etc. If one of those is inputted intentionally, it is judged that an unauthorized access is performed with malicious intent (for example, for the purpose of stealing a drive condition, a keyword, or the like using chip analysis).

The resistor element may contain an organic conductor.

The resistor element may be formed of a capacitor.

A voltage or current larger than at normal operation may be applied to the resistor element in order to change its impedance.

The verification information and standard that are preset in the integrated circuit may contain a keyword, a logic, a clock frequency different from that in a specification, or a power supply voltage different from that in the specification.

The integrated circuit may be formed of an organic semiconductor.

According to the above methods, it is hardly possible to analyze the integrated circuit by an unauthorized access, and thus the safety of the circuit is enhanced. As a result, an inexpensive, highly safe IC card or the like can be realized by using one of the unauthorized access prevention methods described above.

Hereinafter, description will be made of embodiments of the present invention with reference to the drawings.

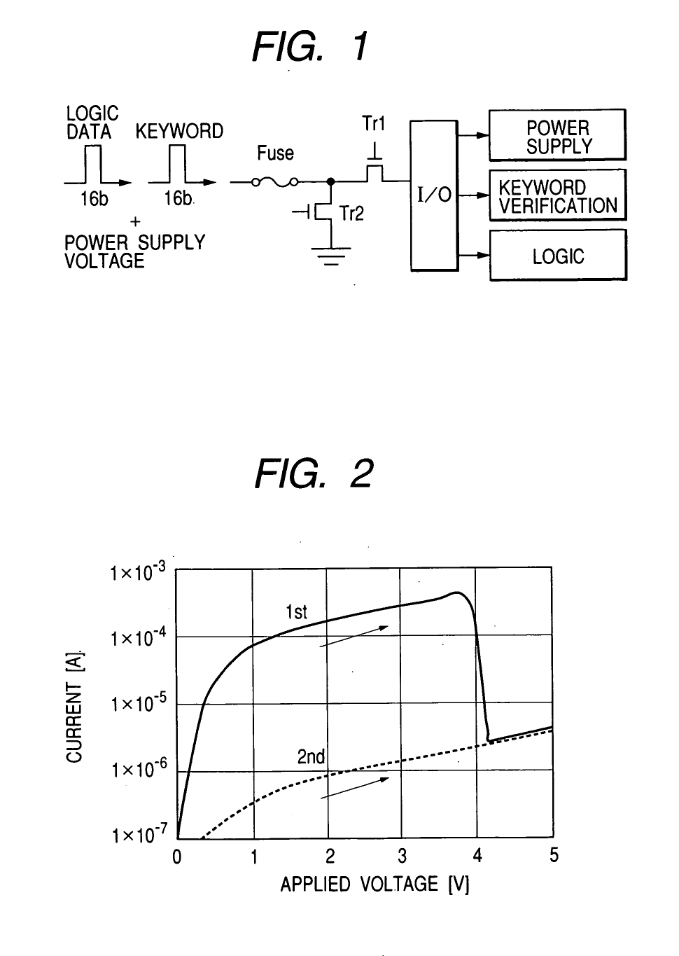

Description is first made of an integrated circuit and an unauthorized access prevention method according to one of the embodiments shown in FIGS. 1 and 2.

### FIRST EMBODIMENT

FIG. 1 shows an example of an interface portion of an integrated circuit. Inputted to an input terminal is a signal containing a signal pulse superposed on a power supply voltage. The signal pulse is composed of a keyword signal of 16 bits and logic data of 16 bits for calculation. An interface circuit includes a circuit for separating the power supply voltage and the signal pulse, in which the keyword signal is fed to a keyword verification circuit and the logic data is fed to a logic circuit. Used as an example of the resistor element capable of selecting between a high impedance state and a low impedance state irreversibly is one that is initially in the low impedance state. The resistor element is referred to herein as “fuse element”, and is attached to the input terminal portion of the interface circuit.

FIG. 2 shows electrical characteristics of the fuse element. The change into the high impedance state is observed around 4 V during the first voltage application. The high impedance state is maintained during the second voltage application, and is never changed into the low impedance state again.

The power supply voltage of FIG. 1 is 5 V or more. While being ready to receive a signal, a transistor 1 (Tr1) is in an ON state and a transistor 2 (Tr2) is in an OFF state. The keyword signal of 16 bits is verified against preset keyword information by the keyword verification circuit. If the keyword is invalid, an NG signal is outputted. In this embodiment, if the invalid keyword is inputted three times in a row, the access is judged as being an unauthorized access. In that case, Tr1 becomes the OFF state and Tr2 becomes the ON state. Then, the power supply voltage is directly applied to the fuse element to change the state of the fuse element into the high impedance state irreversibly. As a result, it becomes impossible for the integrated circuit to receive a power supply voltage and a signal from the outside, thereby prohibiting the access to the integrated circuit.

As the fuse element of FIG. 1, PEDOT/PSS (poly(ethylenedioxythiophene)/polystyrenesulphonic acid) is formed into a line shape with a width of 50 μm by using an ink jet-method, followed by a drive experiment. TFTs (Thin Film Transistors) formed of an organic semiconductor are used only for portions relating to the transistors Tr1 and Tr2 of the interface circuit portion. The substrate is formed of a polyimide film. The TFTs each have a gate length of 50 μm and a gate width of 10 mm.

Assuming that an unauthorized access has been attempted, when Tr1 is turned to the OFF state and Tr2 is turned to the ON state, the state of the fuse element becomes the high impedance state where the access is unacceptable.

### SECOND EMBODIMENT

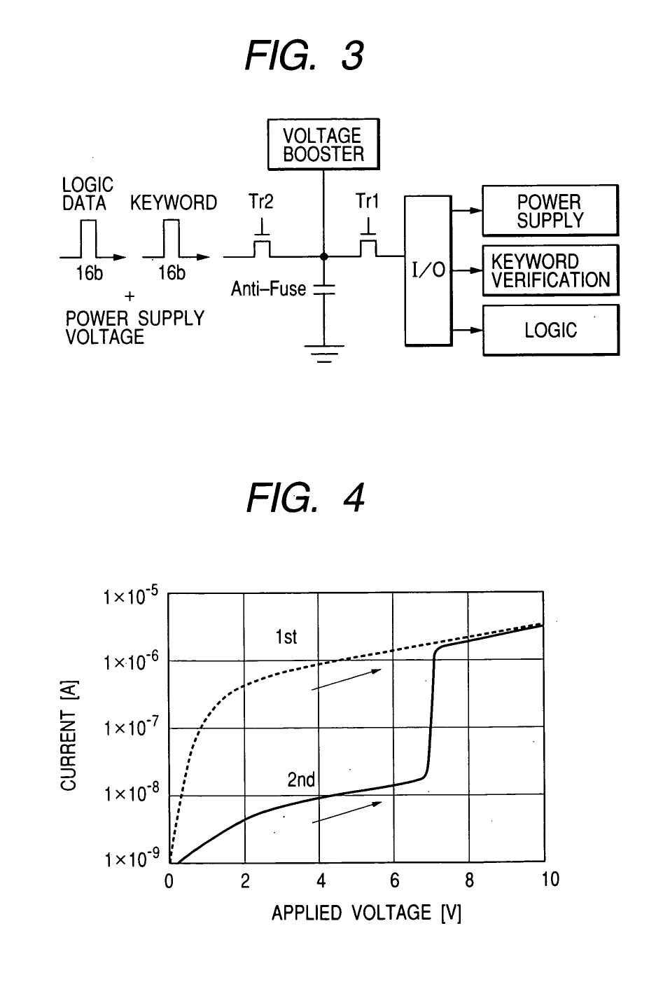

FIG. 3 shows an example of the interface portion of the integrated circuit similarly to the first embodiment. Used as an example of the resistor element capable of selecting between the high impedance state and the low impedance state irreversibly is one that is initially in the high impedance state. The resistor element is referred to herein as “anti-fuse element”, and is attached to the inputting portion of the interface circuit.

FIG. 4 shows electrical characteristics of the anti-fuse element. The change into the low impedance state is observed around 7 V during the first voltage application. The low impedance state is maintained during the second voltage application, and is never changed into the high impedance state again.

The power supply voltage of FIG. 3 is approximately 5 V. While being ready to receive a signal, both the transistor 1 (Tr1) and the transistor 2 (Tr2) are in the ON state. The keyword signal of 16 bits is verified against the preset keyword information by the keyword verification circuit. If the keyword is invalid, the NG signal is outputted. In this embodiment, if the invalid keyword is inputted three times in a row, the access is judged as being the unauthorized access. In that case, both Tr1 and Tr2 become the OFF state. Then, a voltage booster is activated and a high voltage of approximately 10 V is directly applied to the anti-fuse element to change the state of the anti-fuse element into the low impedance state irreversibly. As a result, it becomes impossible for the integrated circuit to receive a power supply voltage and a signal from the outside, thereby prohibiting the access to the integrated circuit.

In this embodiment, an element used as the anti-fuse element has a structure in which a silicon oxide film with high resistance is sandwiched between gold thin films (capacitor structure).

The present invention is not limited to the above embodiments and various changes and modifications can be made within the spirit and scope of the present invention. Therefore to apprise the public of the scope of the present invention, the following claims are made.

1. An unauthorized access prevention method for an integrated circuit comprising one or plural resistor elements capable of selecting between a high impedance state and a low impedance state irreversibly in an interface portion within the integrated circuit or a peripheral circuit portion,
wherein, when a signal inconsistent with verification information and standard that are preset in the integrated circuit is received at least once, the impedance state of the resistor element is changed from an initial state to stop a part or all of accesses to the integrated circuit irreversibly.

2. An unauthorized access prevention method for an integrated circuit as claimed in claim 1, wherein the resistor element contains an organic conductor.

3. An unauthorized access prevention method for an integrated circuit as claimed in claim 1, wherein the resistor element is formed of a capacitor.

4. An unauthorized access prevention method for an integrated circuit as claimed in claim 1, wherein a voltage higher than at normal operation is applied to the resistor element in order to change its impedance.

5. An unauthorized access prevention method for an integrated circuit as claimed in claim 1, wherein a current larger than at normal operation is applied to the resistor element in order to change its impedance.

6. An unauthorized access prevention method for an integrated circuit as claimed in claim 1, wherein the verification information and standard that are preset in the integrated circuit contain a keyword or a logic.

7. An unauthorized access prevention method for an integrated circuit as claimed in claim 1, wherein the verification information and standard that are preset in the integrated circuit contain a clock frequency different from that in a specification.

8. An unauthorized access prevention method for an integrated circuit as claimed in claim 1, wherein the verification information and standard that are preset in the integrated circuit contain a power supply voltage different from that in a specification.

9. An unauthorized access prevention method for an integrated circuit as claimed in claim 1, wherein the integrated circuit contain an organic semiconductor.

10. An IC card which uses the unauthorized access prevention method of claim 1.

11. An IC card which uses the unauthorized access prevention method of claim 2.

12. An IC card which uses the unauthorized access prevention method of claim 3.

13. An IC card which uses the unauthorized access prevention method of claim 4.

14. An IC card which uses the unauthorized access prevention method of claim 5.

15. An IC card which uses the unauthorized access prevention method of claim 6.

16. An IC card which uses the unauthorized access prevention method of claim 7.

17. An IC card which uses the unauthorized access prevention method of claim 8.

18. An IC card which uses the unauthorized access prevention method of claim 9.
